(19) United States
(12) Patent Application Publication
(10) Pub. No.: US 2025/0172164 A1
(43) Pub. Date: May 29, 2025

(54) COMPRESSION LIMITER WITH RETENTION CAPABILITIES

(71) Applicant: GM Global Technology Operations LLC, Detroit, MI (US)

(72) Inventor: Kevin Updike, Canton, MI (US)

(73) Assignee: GM Global Technology Operations LLC, Detroit, MI (US)

(21) Appl. No.: 18/523,108

(22) Filed: Nov. 29, 2023

(51) Int. Cl. F16B 5/02

(52) U.S. Cl. CPC F16B 5/0241

(57) ABSTRACT

A compression limiter of a first part includes a body defining an aperture, a pair of fingers extending from the body into the aperture to a distal end configured to engage with a thread of a bolt of a second part, the first part and the second part being configured to be secured to one another via the bolt passing through the aperture, and a pair of slots on either side of the pair of fingers configured to allow the pair of fingers to flex in response to a force exerted upon the pair of fingers.

### INTRODUCTION

The information provided in this section is for the purpose of generally presenting the context of the disclosure. Work of the presently named inventor, to the extent it is described in this section, as well as aspects of the description that may not otherwise qualify as prior art at the time of filing, are neither expressly nor impliedly admitted as prior art against the present disclosure.

The present disclosure relates generally to over-molded compression limiters. Specifically, the compression limiters described herein may be used to provide and maintain bolted joint integrity of an assembly. The compression limiters may be designed to protect the components of an assembly from the compressive loads generated when a bolt is tightened to its recommended tightening torque, thereby assuring that the joint remains intact throughout the life of the assembly.

In certain applications, two components of an assembly may need to be joined together, e.g., via a bolt fastener, stud, etc. In such applications, it may be desirable to temporarily join the components together so that an installer is not required to hold the components together with one hand (e.g., to prevent the components from coming apart) while permanently joining the components together with the other hand (e.g., by fastening a nut on a bolt). Accordingly, there is room for improvement in compression limiters.

### SUMMARY

One aspect of the disclosure provides a system for a vehicle including a first part including a first aperture, and a compression limiter disposed within the first aperture of the first part, the compression limiter including a body defining a second aperture that is coincident with the first aperture, a pair of fingers extending from the body into the second aperture to a distal end configured to engage with a thread of a bolt of a second part, the first part and the second part being configured to be secured to one another via the bolt passing through the first aperture and the second aperture, and a pair of slots on either side of the pair of fingers configured to allow the pair of fingers to flex in response to a force exerted upon the pair of fingers.

Implementations of the disclosure may include one or more of the following optional features. In some implementations, the compression limiter is formed of a thermoplastic elastomer.

The first part may be formed of one of a plastic or a metal.

The bolt may be configured to receive one of a flange nut or a washer. The body of the compression limiter may include an upper surface that is configured to engage with one of the flange nut or the washer. Each of the pair of fingers may include an upper surface that is spaced below the upper surface of the body of the compression limiter.

When the pair of fingers are engaged with the thread of the bolt, the first part may be at least temporarily secured to the second part.

Another aspect of the disclosure provides a system for a vehicle including a first part including a first aperture, and a compression limiter disposed within the first aperture of the first part, the compression limiter including a body defining a second aperture that is coincident with the first aperture, a pair of fingers extending from the body into the second aperture to a distal end, and a pair of slots on either side of the pair of fingers configured to allow the pair of fingers to flex in response to a force exerted upon the pair of fingers.

Implementations of the disclosure may include one or more of the following optional features. In some implementations, the compression limiter is formed of a thermoplastic elastomer.

The first part may be formed of one of a plastic or a metal.

The distal end of each of the pair of fingers may be configured to engage with a thread of a bolt of a second part, the first part and the second part being configured to be secured to one another via the bolt passing through the first aperture and the second aperture. The bolt may be configured to receive one of a flange nut or a washer. The body of the compression limiter may include an upper surface that is configured to engage with one of the flange nut or the washer. Each of the pair of fingers may include an upper surface that is spaced below the upper surface of the body of the compression limiter.

Another aspect of the disclosure provides a compression limiter of a first part, the compression limiter including a body defining an aperture, a pair of fingers extending from the body into the aperture to a distal end configured to engage with a thread of a bolt of a second part, the first part and the second part being configured to be secured to one another via the bolt passing through the aperture, and a pair of slots on either side of the pair of fingers configured to allow the pair of fingers to flex in response to a force exerted upon the pair of fingers.

Implementations of the disclosure may include one or more of the following optional features. In some implementations, the compression limiter is formed of a thermoplastic elastomer.

The first part may be formed of one of a plastic or a metal.

The bolt may be configured to receive one of a flange nut or a washer. The body of the compression limiter may include an upper surface that is configured to engage with one of the flange nut or the washer.

Each of the pair of fingers may include an upper surface that is spaced below the upper surface of the body of the compression limiter.

The details of one or more implementations of the disclosure are set forth in the accompanying drawings and description below. Other aspects, features, and advantages will be apparent from the description, drawings, and claims.

### BRIEF DESCRIPTION OF THE DRAWINGS

The drawings described herein are for illustrative purposes only of selected configurations and are not intended to limit the scope of the present disclosure.

FIG. 1 is a perspective view of a first part including an exemplary compression limiter that retains the first part to a stud of a second part, in accordance with principles of the present disclosure:

FIG. 2 is a cross sectional view of the compression limiter of FIG. 1, taken along line 2-2 of FIG. 1;

FIG. 3A is a perspective view of the compression limiter of FIG. 1;

FIG. 3B is a side view of the compression limiter of FIG. 1;

FIG. 4 is a perspective view of a first part including another exemplary compression limiter that retains the first part to a stud of a second part, in accordance with principles of the present disclosure;

FIG. 5 is a cross sectional view of the compression limiter of FIG. 4, taken along line 5-5 of FIG. 4;

FIG. 6 is a side view of the compression limiter of FIG. 4;

FIG. 7 is a perspective view of the first part of FIG. 4 with the compression limiter removed for visual clarity;

FIG. 8 is a perspective view of a first part including another exemplary compression limiter that includes an insert that retains the first part to a stud of a second part, in accordance with principles of the present disclosure;

FIG. 9 is a cross sectional view of the compression limiter of FIG. 9, taken along line 9-9 of FIG. 1;

FIG. 10 is a top perspective view of the compression limiter and insert of FIG. 8;

FIG. 11 is a bottom perspective view of the compression limiter and insert of FIG. 8;

FIG. 11A is a top perspective view of a first part including an isolator, in accordance with principles of the present disclosure; and

FIG. 11B is a cross sectional view of the isolator of FIG. 11A, taken along line 11B-11B of FIG. 11A.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including.” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first.” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

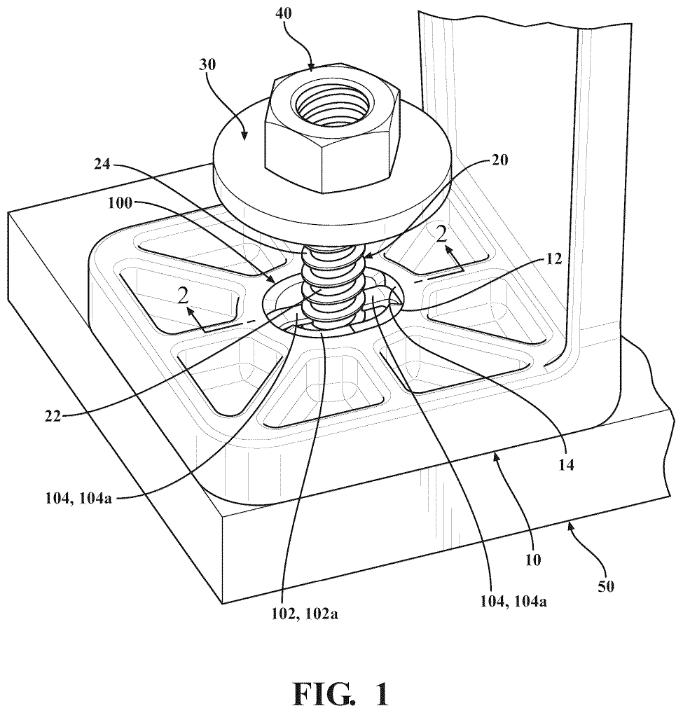

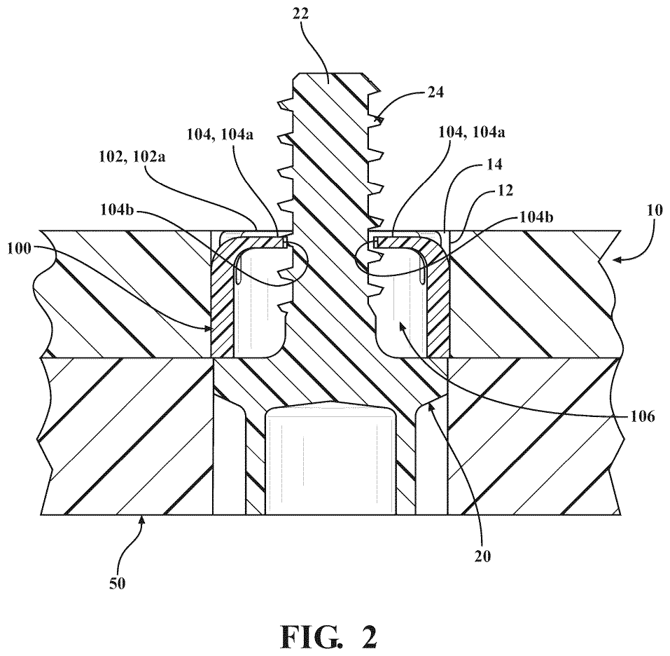

Referring to FIGS. 1-3B, a compression limiter 100 is generally shown. The compression limiter 100 may be used to provide and maintain bolted joint integrity of a plastic assembly or part, e.g., between a first part 10 and a second part 50. The compression limiter 100 may be over-molded with the first part 10 or inserted into an aperture 14 of the first part 10 defined by interior sidewalls 12. The compression limiter 100 may be formed of a thermoplastic elastomer.

The first part 10 and the second part 50 may be for any suitable application, such as a vehicle. The second part 50 may include a bolt 20 that extends away from the second part 50. In some implementations, the bolt 20 is permanently secured to the second part 50, e.g., via welding or other means. The bolt 20 includes a shaft 22 with threads 24 extending along the shaft 22. The bolt 20 is configured to receive a washer 30 and a nut 40. In some implementations, the washer 30 and the nut 40 may be combined into a single component, such as a flange nut. The first part 10 and the second part 50 may each be formed of a plastic material or a metal material.

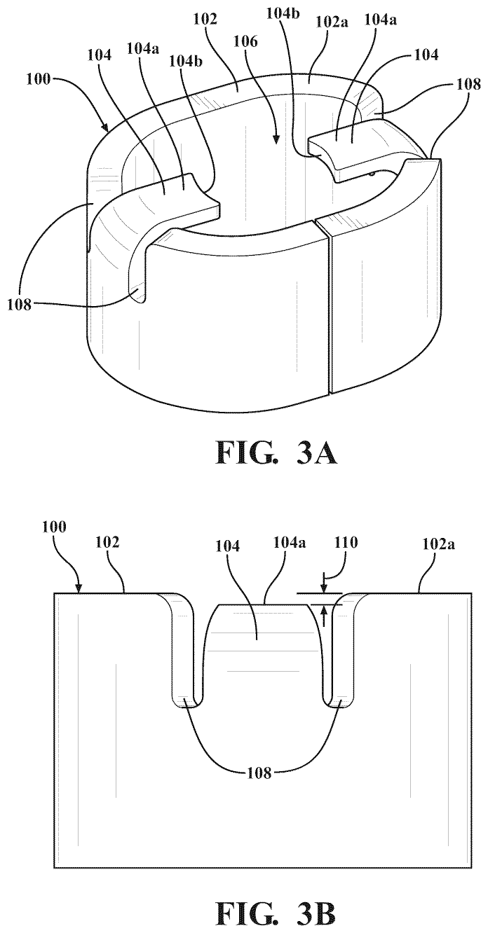

With particular reference to FIGS. 3A and 3B, the compression limiter 100 includes a body 102. While a circular or oval-shaped body 102 is generally shown in the figures, it should be understood that the body 102 may have any suitable shape, such as a triangle, a square, a pentagon, etc. The body 102 includes an upper surface 102a that is configured to engage with the washer 30. The compression limiter 100 includes a pair of fingers 104. The fingers 104 each include an upper surface 104a and a distal surface 104b. The upper surface 104a is spaced below the upper surface 102a of the body 102 by a distance 110, which ensures that the washer 30 engages with the upper surface 102a of the body 102 and is spaced from the upper surface 104a of each finger 104. The distal surface 104b of each finger 104 is configured to extend into an aperture 106 of the compression limiter 100 defined by the body 102 and engage with one or more threads 24 of the bolt 20 to temporarily secure the first part 10 to the second part 50.

The body 102 includes a set of slots 108 on either side of each finger 104. The slots 108 are configured to permit a certain amount of elasticity by the fingers 104. For example, while the first part 10 is being inserted onto the second part 50 with the bolt 20 extending through the aperture 106 of the compression limiter 100, the fingers 104 flex in an upward direction in response to a series of threads 24 sequentially abutting the fingers 104. When the first part 10 is installed onto the second part 50, the distal surface 104b of each finger 104 engages with an adjacent thread 24 of the bolt 20 to temporarily secure the first part 10 to the second part 50. While the first part 10 is temporarily secured to the second part 50, an installer may then remove both hands from the first part 10 and use both hands to more permanently secure the first part 10 to the second part 50, e.g., via attaching the washer 30 and nut 40 to the bolt 20 with any suitable tool. This allows for a quicker and safer installation process because the installer is able to use both hands freely to more permanently secure the first part 10 to the second part 50, rather than forcing the installer to hold the first part 10 with one hand while attempting to use a tool to attach the washer 30 and nut 40 to the bolt 20 with the other hand.

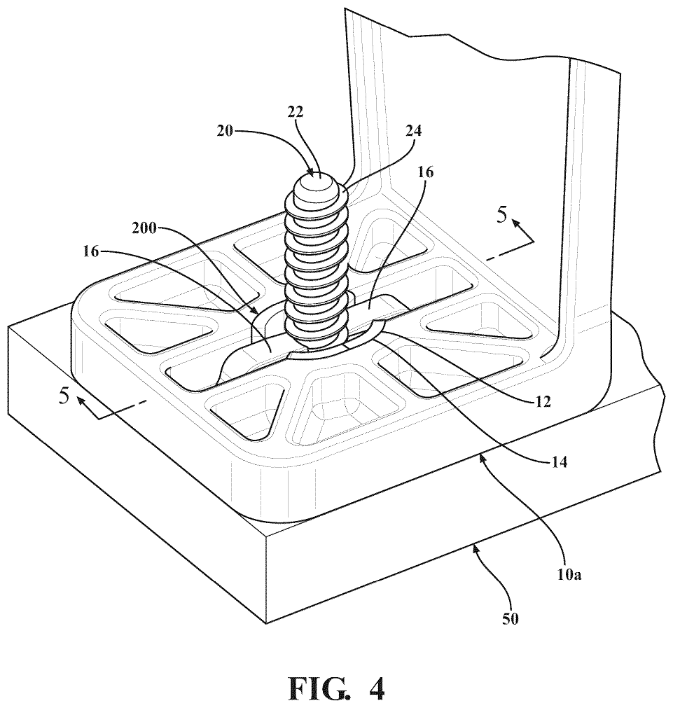

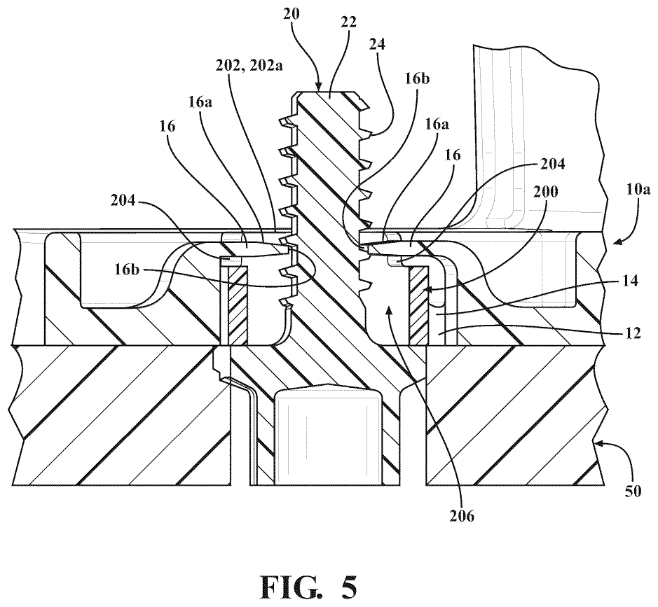

Referring to FIGS. 4-7, a second compression limiter 200 is generally shown. The second compression limiter 200 may be used to provide and maintain bolted joint integrity of a plastic assembly or part, e.g., between a first part 10a and the second part 50. The second compression limiter 200 may be over-molded with the first part 10a or inserted into the aperture 14 of the first part 10a defined by the interior sidewalls 12. The second compression limiter 200 may be formed of a thermoplastic elastomer.

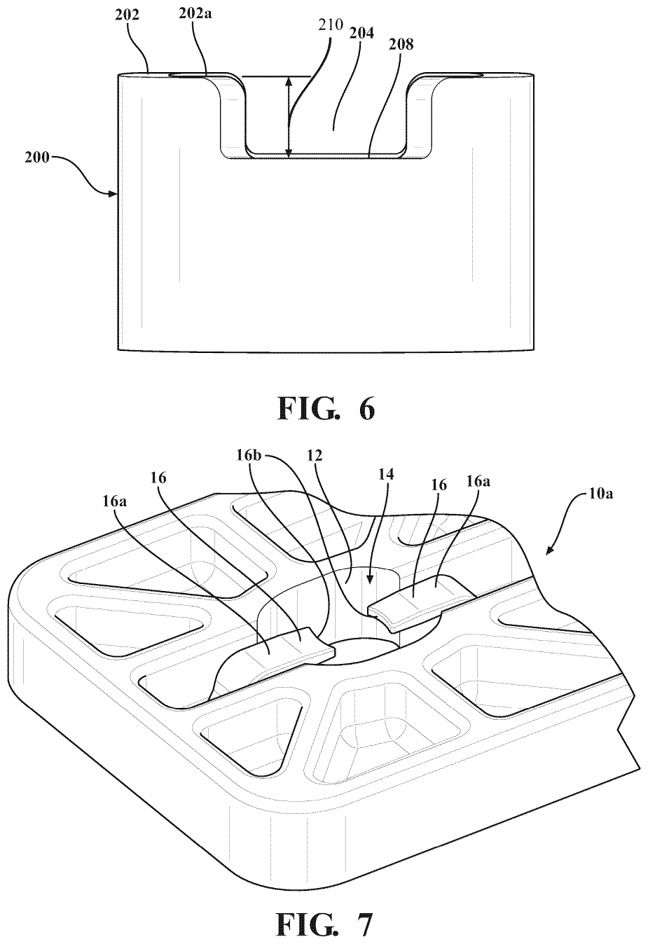

With particular reference to FIG. 6, the second compression limiter 200 includes a body 202. While a circular or oval-shaped body 202 is generally shown in the figures, it should be understood that the body 202 may have any suitable shape, such as a triangle, a square, a pentagon, etc. The body 202 includes an upper surface 202a that is configured to engage with the washer 30. The body 202 includes a pair of slots 204 that permit a portion of the first part 10a to extend into an aperture 206 of the body 202. Each slot 204 defines a lower surface 208 that is spaced from the upper surface 202a of the body 202 by a distance 210.

Referring to FIG. 7, the first part 10a is substantially similar to the first part 10, except the first part 10a includes a pair of fingers 16 extending into the aperture 14. The fingers 16 function similarly to the fingers 104 of the compression limiter 100. For example, the fingers 16 each include an upper surface 16a that is disposed lower than the upper surface 202a of the body 202 to ensure that the washer 30 engages with the upper surface 202a of the body 202 and is spaced from the upper surface 16a of each finger 16. The fingers 16 each include a distal surface 16b that is configured to extend into an aperture 206 of the second compression limiter 200 and engage with one or more threads 24 of the bolt 20 to temporarily secure the first part 10a to the second part 50. In some implementations, the fingers 16 are formed of spring steel.

The first part 10a includes a set of slots located on either side of each finger 16. The slots are configured to permit a certain amount of elasticity by the fingers 16. For example, while the first part 10a is being inserted onto the second part 50 with the bolt 20 extending through the aperture 206 of the second compression limiter 200, the fingers 16 flex in an upward direction in response to a series of threads 24 sequentially abutting the fingers 16. When the first part 10a is installed onto the second part 50, the distal surface 16b of each finger 16 engages with an adjacent thread 24 of the bolt 20 to temporarily secure the first part 10a to the second part 50. While the first part 10a is temporarily secured to the second part 50, an installer may then remove both hands from the first part 10a and use both hands to more permanently secure the first part 10a to the second part 50, e.g., via attaching the washer 30 and nut 40) to the bolt 20 with any suitable tool. This allows for a quicker and safer installation process because the installer is able to use both hands freely to more permanently secure the first part 10a to the second part 50, rather than forcing the installer to hold the first part 10a with one hand while attempting to use a tool to attach the washer 30 and nut 40 to the bolt 20 with the other hand.

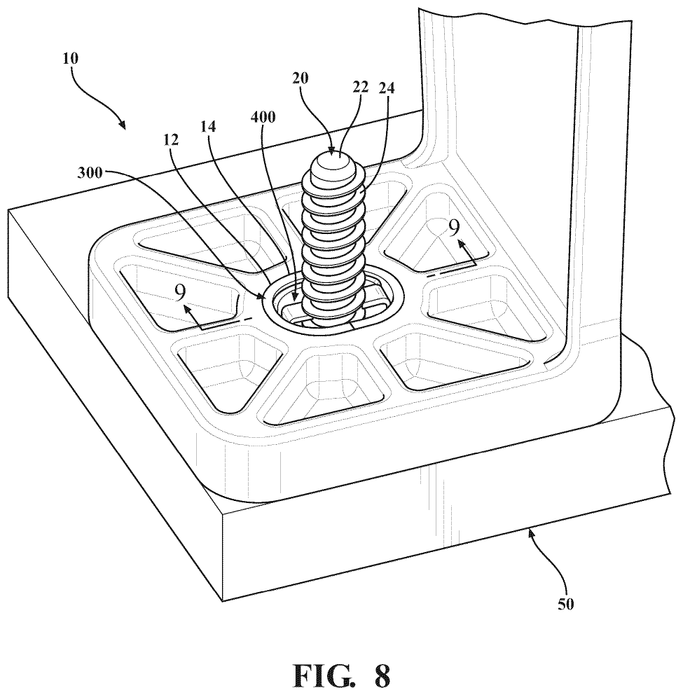

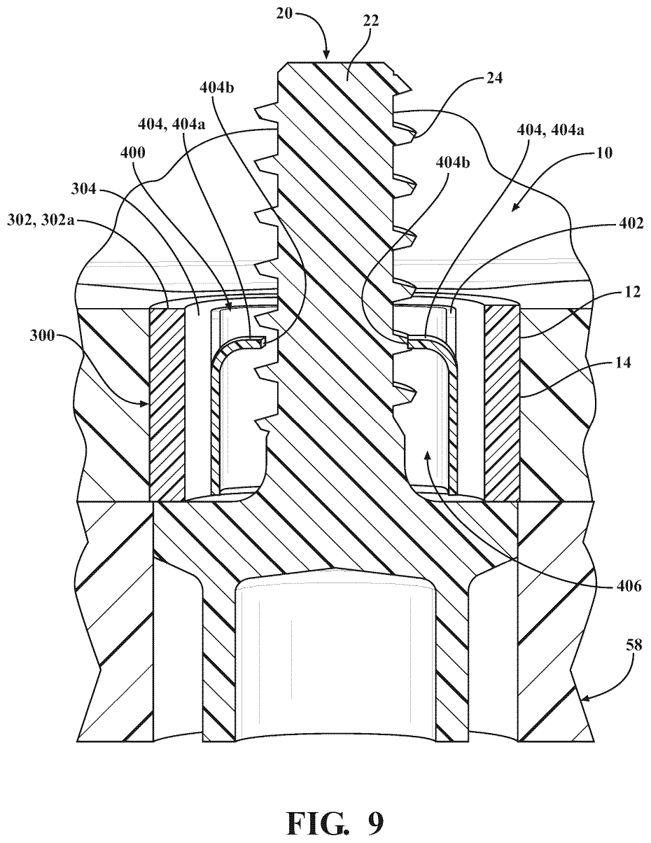

Referring to FIGS. 8-11, a third compression limiter 300 is generally shown. The third compression limiter 300 may be used to provide and maintain bolted joint integrity of a plastic assembly or part, e.g., between the first part 10 and the second part 50. The third compression limiter 300 may be over-molded with the first part 10 or inserted into the aperture 14 of the first part 10. The third compression limiter 300 may be formed of a thermoplastic elastomer.

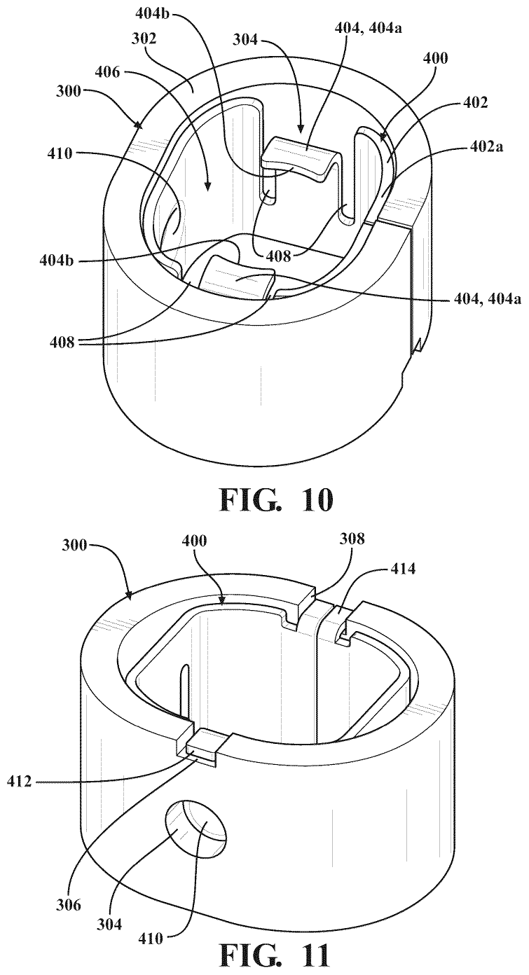

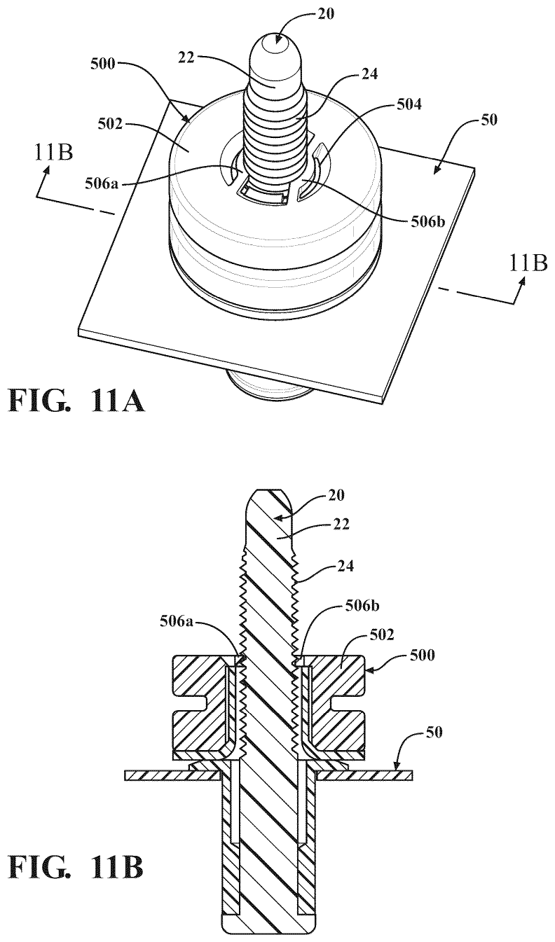

With particular reference to FIGS. 10 and 11, the third compression limiter 300 includes a body 302. While a circular or oval-shaped body 302 is generally shown in the figures, it should be understood that the body 302 may have any suitable shape, such as a triangle, a square, a pentagon, etc. The body 302 includes an upper surface 302a that is configured to engage with the washer 30.

The third compression limiter 300 includes an insert 400 disposed in an interior portion of the third compression limiter 300. The third compression limiter 300 includes an aperture 304 that is configured to receive a protrusion 410 of the insert 400. The third compression limiter 300 includes a first slot 306 and a second slot 308 disposed on a bottom portion of the body 302 that are configured to receive a first tab 412 and a second tab 414, respectively, of the insert 400. The engagement of the protrusion 410 with the aperture 304, the first tab 412 with the first slot 306, and the second tab 414 with the second slot 308 secures the insert 400 to the third compression limiter 300.

The insert 400 includes a body 402 having an upper surface 402a. The insert 400 includes a pair of fingers 404 extending from the body 402 and into an aperture 406 defined by the body 402. Each finger 404 includes an upper surface 404a that is spaced below the upper surface 402a of the body 402. A distal surface 404b of each finger 404 is configured to engage with one or more threads 24 of the bolt 20 to temporarily secure the first part 10 to the second part 50.

The body 402 of the insert 400 includes a set of slots 408 on either side of each finger 404. The slots 408 are configured to permit a certain amount of elasticity by the fingers 404. For example, while the first part 10 is being inserted onto the second part 50 with the bolt 20 extending through the aperture 406 of the insert 400, the fingers 404 flex in an upward direction in response to a series of threads 24 sequentially abutting the fingers 404. When the first part 10 is installed onto the second part 50, the distal surface 404b of each finger 404 engages with an adjacent thread 24 of the bolt 20 to temporarily secure the first part 10 to the second part 50. While the first part 10 is temporarily secured to the second part 50, an installer may then remove both hands from the first part 10 and use both hands to more permanently secure the first part 10 to the second part 50, e.g., via attaching the washer 30 and nut 40 to the bolt 20 with any suitable tool. This allows for a quicker and safer installation process because the installer is able to use both hands freely to more permanently secure the first part 10 to the second part 50, rather than forcing the installer to hold the first part 10 with one hand while attempting to use a tool to attach the washer 30 and nut 40 to the bolt 20 with the other hand.

The foregoing description related to the compression limiters 100, 200, and 300 may equally be applied to anti-vibration mechanisms, such as isolators, dampers, etc. In such implementations, the compression limiters 100, 200, 300 may be formed of any suitable material that dampens or absorbs vibration, e.g., rubber, foam, neoprene, etc.

Referring to FIGS. 11A and 11B, an isolator 500 is generally shown secured to the second part 50. In some examples, the second part 50 may experience vibration forces that passes through the bolt 20. In order to reduce or absorb these vibration forces, the isolator 500 may include a body 502 defining an aperture 504 and first and second tethers 506a, 506b attached to the body 502 and extending across the aperture 504. The tethers 506a, 506b engage the threads 24 of the bolt 20 to retain the bolt 20 in place. The tethers 506a, 506b also are designed such that any vibration forces that transmit through the bolt 20 are received by the tethers 506a, 506b, but are not transmitted to the body 502. That is, the tethers 506a, 506b may flex relative to the bolt 20 in the aperture 504 to absorb the vibration forces.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system for a vehicle comprising:
a first part including a first aperture; and
a compression limiter disposed within the first aperture of the first part, the compression limiter including:
a body defining a second aperture that is coincident with the first aperture;
a pair of fingers extending from the body into the second aperture to a distal end configured to engage with a thread of a bolt of a second part, the first part and the second part being configured to be secured to one another via the bolt passing through the first aperture and the second aperture; and
a pair of slots on either side of the pair of fingers configured to allow the pair of fingers to flex in response to a force exerted upon the pair of fingers.

2. The system of claim 1, wherein the compression limiter is formed of a thermoplastic elastomer.

3. The system of claim 1, wherein the first part is formed of one of a plastic or a metal.

4. The system of claim 1, wherein the bolt is configured to receive one of a flange nut or a washer.

5. The system of claim 4, wherein the body of the compression limiter includes an upper surface that is configured to engage with one of the flange nut or the washer.

6. The system of claim 5, wherein each of the pair of fingers includes an upper surface that is spaced below the upper surface of the body of the compression limiter.

7. The system of claim 1, wherein when the pair of fingers are engaged with the thread of the bolt, the first part is at least temporarily secured to the second part.

8. A system for a vehicle comprising:
a first part including a first aperture; and
a compression limiter disposed within the first aperture of the first part, the compression limiter including:
a body defining a second aperture that is coincident with the first aperture;
a pair of fingers extending from the body into the second aperture to a distal end; and
a pair of slots on either side of the pair of fingers configured to allow the pair of fingers to flex in response to a force exerted upon the pair of fingers.

9. The system of claim 8, wherein the compression limiter is formed of a thermoplastic elastomer.

10. The system of claim 8, wherein the first part is formed of one of a plastic or a metal.

11. The system of claim 8, wherein the distal end of each of the pair of fingers is configured to engage with a thread of a bolt of a second part, the first part and the second part being configured to be secured to one another via the bolt passing through the first aperture and the second aperture.

12. The system of claim 11, wherein the bolt is configured to receive one of a flange nut or a washer.

13. The system of claim 12, wherein the body of the compression limiter includes an upper surface that is configured to engage with one of the flange nut or the washer.

14. The system of claim 13, wherein each of the pair of fingers includes an upper surface that is spaced below the upper surface of the body of the compression limiter.

15. A compression limiter of a first part, the compression limiter comprising:
a body defining an aperture;
a pair of fingers extending from the body into the aperture to a distal end configured to engage with a thread of a bolt of a second part, the first part and the second part being configured to be secured to one another via the bolt passing through the aperture; and
a pair of slots on either side of the pair of fingers configured to allow the pair of fingers to flex in response to a force exerted upon the pair of fingers.

16. The compression limiter of claim 15, wherein the compression limiter is formed of a thermoplastic elastomer.

17. The compression limiter of claim 15, wherein the first part is formed of one of a plastic or a metal.

18. The compression limiter of claim 15, wherein the bolt is configured to receive one of a flange nut or a washer.

19. The compression limiter of claim 18, wherein the body of the compression limiter includes an upper surface that is configured to engage with one of the flange nut or the washer.

20. The compression limiter of claim 15, wherein each of the pair of fingers includes an upper surface that is spaced below the upper surface of the body of the compression limiter.
